(19) United States
(12) Patent Application Publication
(10) Pub. No.: US 2026/0051322 A1
(43) Pub. Date: Feb. 19, 2026

(54) SYSTEMS AND METHODS FOR NOTE GENERATION

(71) Applicant: GE Precision Healthcare LLC, Waukesha, WI (US)

(72) Inventors: Xiaoqing Shangguan, Shanghai (CN); Yuqing Ma, Shanghai (CN); Yongchao Yang, Shanghai (CN)

(21) Appl. No.: 19/299,218

(22) Filed: Aug. 13, 2025

(30) Foreign Application Priority Data
Aug. 14, 2024 (CN) 202411113837.7

(51) Int. Cl. G10L 15/22; G06F 16/34; G06F 40/253; G10L 15/26

(52) U.S. Cl. CPC G10L 15/22; G06F 16/345; G06F 40/253; G10L 15/26

(57) ABSTRACT

Embodiments of the present specification provide a note generation method and apparatus and a computer device. The note generation method includes performing speech recognition on data of a guidance process and obtaining text data; extracting a guidance summary according to the text data; retrieving augmentation information associated with the guidance summary; and generating a note of the guidance process according to the augmentation information and the guidance summary. The embodiments of the present specification can improve the readability and practicability of the generated note.

### TECHNICAL FIELD

The present specification relates to the field of computer technology, and more specifically to methods, systems, and computer-readable media for note generation.

### BACKGROUND

Notes can be used to record information. For example, in online conferences, notes can be used to record conference content. For another example, in learning and training, notes can be used to record training content.

It should be noted that the above introduction of the background is only for the convenience of clearly and completely describing the technical solutions of the present specification, and for the convenience of understanding for those skilled in the art.

### SUMMARY OF THE INVENTION

A guidance recipient, when encountering problems, may seek assistance from a guidance provider. The guidance provider may provide assistance to the guidance recipient. To prevent knowledge during a guidance process from being forgotten, notes may be generated after the guidance process is completed, for the guidance recipient to study. In the related art, dialogue between the guidance provider and the guidance recipient during the guidance process is typically recorded to obtain a note of the guidance process. The inventors have found that: according to the above note generation method, dialogue between a guidance provider and a guidance recipient is faithfully recorded, but not subjected to analysis processing, and the dialogue between the guidance provider and the guidance recipient contains a large amount of information without substantive content, resulting in poor readability and practicality of notes.

To solve at least one of the above technical problems or similar technical problems, embodiments of the present specification provide techniques for note generation to improve the readability and practicality of generated notes.

According to one aspect of the embodiments of the present specification, a note generation method is provided. The method comprises: performing speech recognition on data of a guidance process and obtaining text data; extracting a guidance summary according to the text data; retrieving augmentation information associated with the guidance summary; and generating a note of the guidance process according to the augmentation information and the guidance summary.

According to another aspect of the embodiments of the present application, a note generation apparatus is provided. The apparatus comprises: a text acquisition unit, configured to perform speech recognition on data of a guidance process and obtain text data; an extraction unit, configured to extract a guidance summary according to the text data; a retrieval unit, configured to retrieve augmentation information associated with the guidance summary; and a generation unit, configured to generate a note of the guidance process according to the augmentation information and the guidance summary.

According to another aspect of the embodiments of the present application, a computer device is provided. The computer device comprises: at least one processor; and a memory storing program instructions, wherein the program instructions are configured to be adapted to be executed by the at least one processor, and the program instructions comprise instructions for executing the above-mentioned note generation method.

In the note generation method according to the embodiments of the present specification, speech recognition may be performed on data of a guidance process, and text data is obtained, a guidance summary is extracted from the text data, augmentation information associated with the guidance summary is retrieved, and a note of the guidance process is generated according to the augmentation information and the guidance summary. The guidance summary comprised in the note is an inductive summarization of the content expressed by the guidance provider and/or the guidance recipient during the guidance process, and can accurately and concisely represent the key points expressed by the guidance provider and/or the guidance recipient during the guidance process. Further, the augmentation information associated with the guidance summary comprised in the note may assist in understanding the guidance summary. Therefore, the note generated in the embodiments of the present specification has good readability and practicability. The guidance recipient, by reading the note, can quickly understand or apply the knowledge from the guidance process, thereby improving the skills of the guidance recipient.

With reference to the following description and drawings, implementations of the embodiments of the present specification are disclosed in detail, and the manners in which the principles of the embodiments of the present specification can be employed are illustrated. It should be understood that the implementations of the present specification are not limited in scope thereby. Within the spirit and the scope of clauses of the appended claims, the implementations of the present specification include many changes, modifications, and equivalents.

### BRIEF DESCRIPTION OF THE DRAWINGS

The included drawings are used to provide further understanding of the embodiments of the present specification. The drawings constitute a part of the description, and are used to illustrate the implementations of the present specification, and together with the written description, explain the technical principles of the embodiments of the present specification. Obviously, the drawings in the following description are only some embodiments of the present specification, and those of ordinary skill in the art may obtain other implementations according to the drawings without the exercise of inventive effort. In the drawings:

FIG. 1 is a schematic diagram of the architecture of a note generation system in some embodiments of the present specification;

FIG. 2 is a schematic flowchart of a note generation method in some embodiments of the present specification;

FIG. 3 is a schematic diagram of a note generation approach in some embodiments of the present specification;

FIG. 4 is a schematic flowchart of a note generation approach in other embodiments of the present specification;

FIG. 5 is a structural schematic diagram of a note generation apparatus in some embodiments of this specification; and

FIG. 6 is a schematic diagram of the architecture of a computer device in some embodiments of the present specification.

### DETAILED DESCRIPTION

The technical solutions in the embodiments of the present specification will be clearly and completely described below with reference to the drawings in the embodiments of the present specification. Obviously, the described embodiments are only some, but not all, of the embodiments of the present specification. The specific embodiments described herein are merely configured to explain the present disclosure, rather than to limit the present disclosure. All other embodiments obtained by those of ordinary skill in the art based on the described embodiments of the present disclosure fall within the scope of protection of the present disclosure. In addition, relational terms such as “first” and “second” are used merely to distinguish one entity or operation from another entity or operation, and do not necessarily require or imply that any such actual relationship or sequence exists between these entities or operations.

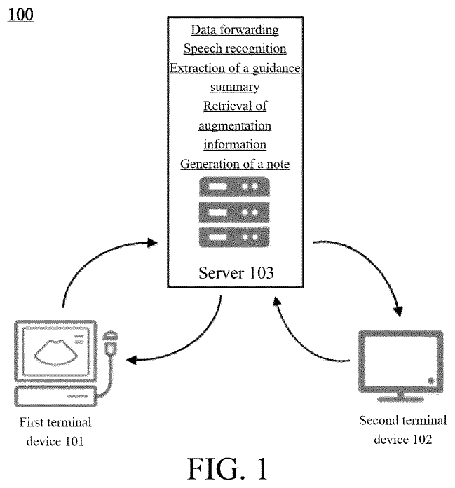

FIG. 1 is a schematic diagram of the architecture of a note generation system in some embodiments of the present specification.

As shown in FIG. 1, the note generation system 100 is used for interactive communication between a guidance provider and a guidance recipient during a guidance process. The note generation system 100 may include a first terminal device 101, a second terminal device 102, and a server 103.

The first terminal device 101 is a guidance provider-oriented device, and is configured to acquire data of the guidance provider during the guidance process. The second terminal device 102 is a guidance recipient-oriented device, and is configured to acquire data of the guidance recipient during the guidance process. The server 103 may perform speech recognition on the data of the guidance provider and the guidance recipient during the guidance process to obtain text data; may extract a guidance summary according to the text data; may retrieve augmentation information associated with the guidance summary; and may generate a note of the guidance process according to the augmentation information and the guidance summary. The note generated in this way not only includes the guidance summary of the guidance process, but also includes additional augmentation information. The readability and practicality of the note are improved. The guidance recipient, by reading the note, can quickly understand or apply the knowledge from the guidance process, thereby improving the skills of the guidance recipient.

In some embodiments, the guidance process is used for guidance providers (e.g., individuals with rich knowledge) to impart knowledge to guidance recipients (e.g., individuals that relatively lack knowledge).

The guidance process may include a remote guidance process. Remote guidance, also known as remote assistance, remote support, online guidance, or online instruction, refers to non-face-to-face guidance implemented using communication technology. For example, during the remote guidance process, the guidance provider may guide the guidance recipient by means of video conferencing, image sharing, or remote control, or the guidance provider may guide the guidance recipient by means of telephone, email, or pre-recorded video. It may be that one guidance provider gives guidance to one or more guidance recipients, or a plurality of guidance providers give guidance to one or more guidance recipients.

Forms of the guidance process may include video conferencing, teleconferencing, learning and training, consultation, telemedicine, etc. According to different forms of the guidance process, the guidance provider and the guidance recipient may be different, and the knowledge imparted may be different. For example, the guidance process may include learning and training, the guidance provider may include a trainer, the guidance recipient may include a trainee, and the knowledge imparted may include training content. For another example, the guidance process may include consultation, the guidance provider may include customer service staff, the guidance recipient may include a user, and the knowledge imparted may include question answers. For another example, the guidance process may include telemedicine, the guidance provider may include an expert, the guidance recipient may include a general doctor or a patient, and the knowledge imparted may include medical knowledge.

In some embodiments, the note generation system 100 includes one or more first terminal devices 101. The first terminal device 101 may include computer devices such as a smartphone, a portable computer, a desktop computer, and the server 103; may also include medical devices such as an ultrasound device, a computed tomography (CT) device, and a magnetic resonance imaging (MRI) device; and may further include a fixed telephone, etc. The first terminal device 101 includes data acquisition components. The first terminal device 101 may acquire the data of the guidance provider through the data acquisition components. The data acquisition components may include a sound acquisition component (e.g., a microphone), a video acquisition component (e.g., a camera), etc. The data acquired by the first terminal device 101 includes data including sound, such as audio data and video data.

In some embodiments, the note generation system 100 includes one or more second terminal devices 102. The second terminal device 102 may include computer devices such as a smartphone, a portable computer, a desktop computer, and the server 103; may also include medical devices such as an ultrasound device, a CT (computed tomography) device, and an MRI (magnetic resonance imaging) device; and may further include a fixed telephone, etc. The second terminal device 102 includes data acquisition components. The second terminal device 102 may acquire the data of the guidance recipient through the data acquisition components. The data acquisition components may include a sound acquisition component (e.g., a microphone), a video acquisition component (e.g., a camera), etc. The data acquired by the second terminal device 102 includes data including sound, such as audio data and video data.

In some embodiments, the server 103 may be one server, or may be a cluster formed by a plurality of servers. The server 103 may generate the note of the guidance process according to the data of the guidance provider and the data of the guidance recipient during the guidance process.

In some embodiments, the guidance recipient, when encountering problems, may seek assistance from the guidance provider. Through the note generation system 100, the guidance provider can provide assistance to the guidance recipient. The server 103 in the note generation system 100 can generate the note of the guidance process.

The first terminal device 101 may acquire the data (e.g., first data) of the guidance provider during the guidance process and transmit the data of the guidance provider to the server 103, the server 103 may transmit the data of the guidance provider to the second terminal device 102, and the second terminal device 102 may receive the data of the guidance provider from the server 103. The second terminal device 102 may acquire the data (e.g., second data) of the guidance recipient during the guidance process and transmit the data of the guidance recipient to the server 103, the server 103 may transmit the data of the guidance recipient to the first terminal device 101, and the first terminal device 101 may receive the data of the guidance recipient from the server 103. In this way, the server 103 forwards the data of the guidance provider and the data of the guidance recipient, thereby facilitating the interactive communication between the guidance provider and the guidance recipient.

In some embodiments, the server 103 may fuse the data of the guidance provider and the data of the guidance recipient (e.g., fuse according to a conversation sequence of the guidance provider and the guidance recipient), and separately transmits the fused data to the first terminal device 101 and the second terminal device 102. In this way, both the guidance provider and the guidance recipient can obtain complete conversation data during the guidance process.

After the guidance process ends or during the guidance process, the server 103 may perform speech recognition on the data of the guidance provider and the data of the guidance recipient, respectively, to obtain first text data of the guidance provider and second text data of the guidance recipient, and then fuse the first text data and the second text data to obtain the text data for extracting the guidance summary.

The server 103 may further process the fused text data to generate a note including the guidance summary and the augmentation information. The note can facilitate the guidance recipient to quickly understand or apply the knowledge from the guidance process, thereby improving the skills of the guidance recipient.

In some embodiments, the server 103 may further transmit the generated note to the second terminal device 102. In this way, the guidance recipient can obtain the note after the guidance process is completed.

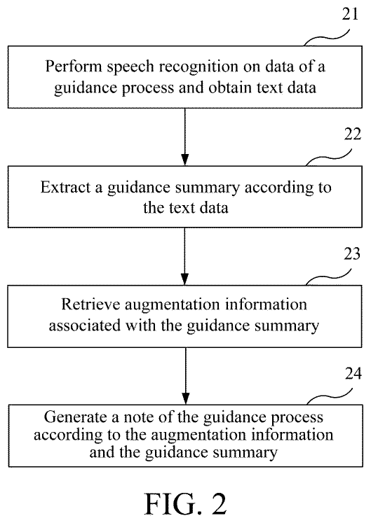

Some embodiments of the present specification further provide a note generation method. The note generation method can be applied to the server 103. As shown in FIG. 2, the note generation method may include the following steps:

Step 21: performing speech recognition on data of a guidance process and obtaining text data;

Step 22: extracting a guidance summary according to the text data;

Step 23: retrieving augmentation information associated with the guidance summary; and

Step 24: generating a note of the guidance process according to the augmentation information and the guidance summary.

It should be noted that FIG. 2 shows only one possible sequence of steps, and it is not necessary to strictly follow this sequence of steps in practice. For example, some steps may be performed in parallel independently of each other. The embodiments of the present specification may include more or less steps based on conventional rules or non-inventive effort.

In some embodiments of Step 21, the guidance process is used for a guidance provider to impart knowledge to a guidance recipient. Forms of the guidance process may include video conferencing, teleconferencing, learning and training, consultation, telemedicine, etc. For example, the guidance process may include learning and training, the guidance provider may include a trainer, the guidance recipient may include a trainee, and the knowledge imparted may include training content. For another example, the guidance process may include consultation, the guidance provider may include customer service staff, the guidance recipient may include a user, and the knowledge imparted may include question answers. For another example, the guidance process may include telemedicine, the guidance provider may include an expert, the guidance recipient may include a general doctor or a patient, and the knowledge imparted may include medical knowledge.

In some embodiments, the data of the guidance process is configured to represent content expressed by the guidance provider and the guidance recipient. The data of the guidance process may include data including sound, such as audio data and video data.

In some embodiments of Step 21, the server 103 may perform speech recognition on the data of the guidance process using speech recognition technology, to obtain the text data. The speech recognition technology is, for example, automatic speech recognition (ASR). The text data may include speech-recognized textual elements.

For example, the data of the guidance process includes audio data, and the server 103 may perform speech recognition on the audio data to obtain the text data. For another example, the data of the guidance process includes video data, and the server 103 may extract audio data from the video data, and then perform speech recognition on the extracted audio data to obtain the text data.

In some embodiments, the data of the guidance process may include the first data of the guidance provider and the second data of the guidance recipient. The first data is configured to represent the content expressed by the guidance provider. The first data may include data including sound, such as audio data and video data. The second data is configured to represent the content expressed by the guidance recipient. The second data may include data including sound, such as audio data and video data. The data of the guidance process may include a fusion of the first data and the second data. The server 103 may perform speech recognition on the data of the guidance process to obtain the text data for extracting the guidance summary. Alternatively, the data of the guidance process may further include first data and second data that are independent of each other. The server 103 may perform speech recognition on the first data to obtain first text data; and may perform speech recognition on the second data to obtain second text data. The first text data and the second text data may be fused according to a conversation sequence of the guidance provider and the guidance recipient to obtain the text data for extracting the guidance summary.

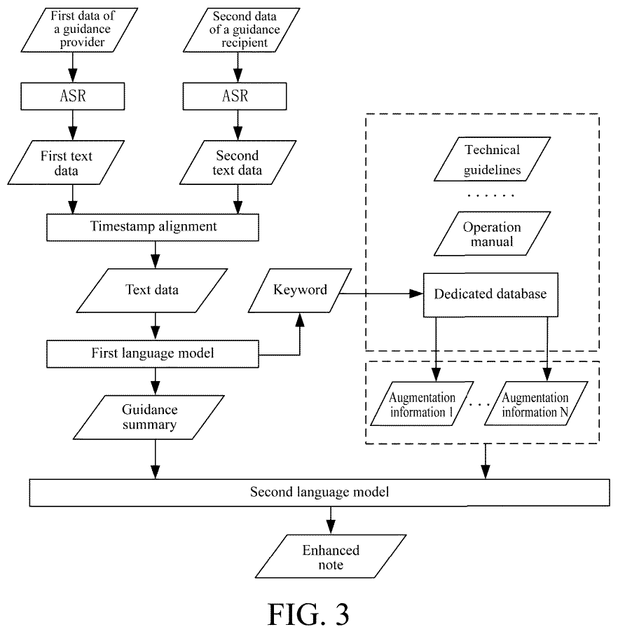

FIG. 3 is a schematic flowchart of a note generation method in some embodiments of the present specification. As shown in FIG. 3, speech recognition is performed on first data and second data based on an ASR method to obtain first text data and second text data. The first text data and the second text data are, for example, text data carrying timestamps. The server 103 may fuse the first text data and the second text data by means of timestamp alignment. The text data subjected to timestamp alignment includes conversation sequence information of a guidance provider and a guidance recipient, thereby facilitating accurate extraction of a designated summary.

In some examples, the first text data includes a first textual element and a first timestamp, and the first timestamp has a correspondence with the first textual element, where the first timestamp is configured to represent time information when the guidance provider expresses the first textual element; and the second text data includes a second textual element and a second timestamp, and the second timestamp has a correspondence with the second textual element, where the second timestamp is configured to represent time information when the guidance provider expresses the second textual element. The server 103 may determine the chronological sequence of the first textual element and the second textual element according to the first timestamp and the second timestamp. The chronological sequence of the first textual element and the second textual element reflects a conversation sequence of the guidance provider and the guidance recipient. The server 103 may fuse the first text data and the second text data according to the sequence of the first textual element and the second textual element.

For example, the guidance process may include telemedicine. The guidance provider may include an expert, and the guidance recipient may include a general doctor. Telemedicine is used by experts to provide ultrasound guidance to the general doctor. The text data subjected to timestamp alignment includes the content shown in Table 1 below.

TABLE 1
General doctor: I am having difficulty obtaining a clear image of the gallbladder. Could
you take a look and provide some guidance?
Expert: Of course! Could you show me the current image and the settings you're using?

In some embodiments, the guidance summary is an inductive summarization of the content expressed by the guidance provider and/or the guidance recipient during the guidance process. The guidance summary filters out the content that is not substantively meaningful in the text data, and can accurately and concisely represent the key points expressed by the guidance provider and/or the guidance recipient during the guidance process. The guidance summary may include one or more of textual elements, images, videos, and audio.

In some embodiments of Step 22, the server 103 may, according to the text data, generate the guidance summary using a first language model. For example, the server 103 may input the text data into the first language model to obtain a guidance summary outputted by the first language model. The language models (LM) are constructed by linguistic abstract mathematical modeling performed according to objective linguistic facts. The language model may include a long short term memory (LSTM) model, a large language model (LLM), or the like. The large language model may include ChatGPT, Llama, etc. The first language model is configured to extract the guidance summary. The first language model may be a general-purpose model or a dedicated model. The dedicated model is a model trained for specific needs, for example, a model trained for a specific domain or a specific task (e.g., a remote assistance scenario for a medical imaging device). The dedicated model can improve the quality of the extracted guidance summary.

In some embodiments, the guidance summary can be generated using the first language model only according to the text data.

In other embodiments, different guidance prompts may be provided for the first language model, so that the first language model outputs corresponding content according to the guidance prompts and the text data. Thus, the server 103 may, according to first prompt data and the text data, generate the guidance summary using the first language model. For example, the server 103 may input the first prompt data and the text data obtained in Step 21 into the first language model to obtain the guidance summary outputted by the first language model. Prompting using the first prompt data can enhance the comprehension of the text data by the first language model, which is beneficial for extracting a high-quality summary.

In some examples, the first prompt data may be default.

In other examples, the server 103 may acquire a first prompt word according to the text data, and then acquire the first prompt data according to the first prompt word. In this way, the first prompt data may match the text data, to achieve personalized prompting performed on the first language model for the text data.

In the present application, there are one or more first prompt words, and the one or more first prompt words are configured to represent one or more types of environment information of the guidance process. The environment information represented by the first prompt word includes at least one of the domain of the guidance process and identity information of the guidance recipient.

The first prompt data is configured to represent a first constraint condition for the guidance summary. The first constraint condition is configured to constrain at least one of a subject matter, a word count, an expression style, and a format of the guidance summary. For example, the first constraint condition is configured to constrain that: the subject matter of the guidance summary is an ultrasound scan, the word count of the guidance summary is less than or equal to 1000 words, the guidance summary has an expression style suitable for beginners, and the format of the guidance summary is an “introduction-body-conclusion” (i.e., topic-supporting details-recap) format. The first constraint condition represented by the first prompt data may restrict the first language model so that the first language model outputs a guidance summary that satisfies the requirements of the first constraint condition.

The first constraint condition may match the environment information represented by the first prompt word.

In some scenario examples, the first prompt word is configured to represent the domain of the guidance process. The first constraint condition may include the subject matter of the guidance summary conforming to the domain represented by the first prompt word. For example, the first prompt word may include “ultrasound domain”, and the first constraint condition may include “please write a note about ultrasound knowledge according to the text data”.

In other scenario examples, the first prompt word is configured to represent the identity information of the guidance recipient. The first constraint condition may include the expression style of the guidance summary matching the identity information of the guidance recipient. In this way, the guidance summary outputted by the first language model can match the cognitive level of the guidance recipient, so that the guidance recipient can quickly understand the guidance summary. For example, the first prompt word may include “beginner”. The first constraint condition may include “please write a note from the perspective of a beginner according to the text data”. For another example, the first prompt word may include “expert”, and the first constraint condition may include “please write a note from the perspective of an expert according to the text data”. It can be understood that the identity information may include information such as the professional field, proficiency level in the professional field, and cognitive level of the guidance recipient.

The server 103 may select the first prompt word from the text data. For example, the server 103 may select a representative word (e.g., the representative word may be a word of which the frequency of occurrence in the text data meets a predetermined requirement) from the text data as the first prompt word; alternatively, the server 103 may perform semantic analysis on the text data, and generate the first prompt word according to the semantic meaning of the text data. In addition, the server 103 may also acquire the first prompt word in other ways.

The server 103 may select prompt data matching the first prompt word from a first prompt data set as the first prompt data. The first prompt data set includes one or more pieces of prompt data. The prompt data in the first prompt data set is configured to prompt the first language model. For example, the server 103 may select prompt data including the first prompt word from the first prompt data set as the first prompt data; alternatively, the server 103 may also acquire a first prompt template, and generate the first prompt data according to the first prompt word and the first prompt template. The first prompt template is pre-generated based on prompt engineering. The first prompt template may include a preset textual element and a first position identifier. The first position identifier is configured to indicate the position of the prompt word. The server 103 may replace the first position identifier in the first prompt template with the first prompt word to obtain the first prompt data. The preset textual element in the first prompt template is combined with the first prompt word to collectively express the first constraint condition.

In some examples, the first prompt template may be default. In other examples, the guidance recipient may input first configuration information into the second terminal device 102, the second terminal device 102 may transmit the first configuration information to the server 103, and the server 103 may generate the first prompt template according to the first configuration information. The first configuration information includes personalized requirement information of the guidance recipient for the guidance summary. The personalized requirement information may include, for example: the guidance summary is expressed in a combination of text and graphics for ease of reading. In this way, the server 103 may prompt the first language model according to personalized requirements of the guidance recipient, to obtain a guidance summary that meets the personalized requirements of the guidance recipient.

The first prompt word may correspond to a dimension identifier, and is configured to represent environment information in a dimension corresponding to the dimension identifier. The first prompt template includes the first position identifier. The first position identifier may include the dimension identifier. The server 103 may use each first prompt word to replace the dimension identifier corresponding to that first prompt word in the first prompt template.

In some scenario examples, the first prompt word may include “ultrasound domain” and “beginner”. “Ultrasound domain” may correspond to a dimension identifier domain, where the dimension identifier domain is configured to identify a domain dimension. The beginner may correspond to a dimension identifier level, where the dimension identifier level is configured to identify a cognitive level dimension. Table 2 is an example of the pre-generated first prompt template.

```
TABLE 2
  You are a note assistant. Please write a description (no more than 1000 words, and no
fabrication is allowed in the answer) for {level} according to the dialogue content in the text
data. Then list some key phrases (no more than 5) about the knowledge of {domain} from
this. Please answer me in this format:
  Note:
  [Write your note here]
  Keywords:
  1. [Keyword 1]
  2. [Keyword 2]
  [...if there are others]
```

The server 103 may replace the first position identifier with the first prompt word to obtain the first prompt data as shown in Table 3.

```
TABLE 3
  You are a note assistant. Please write a description (no more than 1000 words, and no
fabrication is allowed in the answer) for a beginner according to the dialogue content in the
following text data. Then list some key phrases (no more than 5) about the knowledge of the
ultrasound domain from this. Please answer me in this format:
  Note:
  [Write your note here]
  Keywords:
  1. [Keyword 1]
  2. [Keyword 2]
  [...if there are others]
```

In some implementations of the present embodiment, the server 103 may separately input the first prompt data and the text data into the first language model to obtain the guidance summary. In other implementations of the present embodiment, the server 103 may also fuse the first prompt data and the text data, and input the fused data to the first language model to obtain the guidance summary. For example, the server 103 may generate first prompt data fused with the text data according to the first prompt word, the text data, and the first prompt template, and input the first prompt data fused with the text data into the first language model to obtain the guidance summary. By fusing the first prompt data and the text data first, and then inputting the fused first prompt data and text data into the first language model, the first language model can fully understand the contextual relevance between the first prompt data and the text data, thereby improving the quality of the guidance summary outputted by the first language model.

In addition to the preset textual element and the first position identifier, the first prompt template may further include a second position identifier. The second position identifier is configured to indicate the position of the text data. The server 103 may replace the first position identifier with the first prompt word, and may replace the second position identifier with the text data, to obtain the first prompt data fused with the text data.

In some scenario examples, the first prompt word may include “ultrasound domain” and “beginner”. “Ultrasound domain” may correspond to a dimension identifier domain, and the dimension identifier domain is configured to identify a domain dimension. “Beginner” may correspond to a dimension identifier level, and the dimension identifier level is configured to identify a cognitive level dimension. The second position identifier may be text. The first prompt template may be as shown in Table 4 below.

```
TABLE 4
  You are a note assistant. Please write a description (no more than 1000 words, and no
fabrication is allowed in the answer) for {level} according to the dialog content in the
following text data. Then list some key phrases (no more than 5) about the knowledge of
{domain} from this. Please answer me in this format:
  Note:
  [Write your note here]
  Keywords:
  1. [Keyword 1]
  2. [Keyword 2]
  [...if there are others]
  The following is the dialogue text:
  [Text]
```

The server 103 may replace the first position identifier with the first prompt word; and may replace the second position identifier with the text data, to obtain the first prompt data fused with the text data shown in Table 5.

```
TABLE 5
  You are a note assistant. Please write a description (no more than 1000 words, and no
fabrication is allowed in the answer) for a beginner according to the dialogue content in the
following text data. Then list some key phrases (no more than 5) about the knowledge of the
ultrasound domain from this. Please answer me in this format:
  Note:
  [Write your note here]
  Keywords:
  1. [Keyword 1]
  2. [Keyword 2]
  [...if there are others]
  The following is the dialogue text:
  <Text data>
```

In some embodiments of Step 22, the server 103 may further acquire keywords of the text data. There are one or more keywords, and the keywords are configured to represent key information of the guidance process.

In some examples, the server 103 may select the keywords from the text data. For example, the server 103 may select, as the keyword, a headword of a questioning sentence of the guidance recipient from the text data.

In other examples, the server 103 may also generate a keyword according to the semantic meaning of the text data; alternatively, the guidance summary may include one or more keywords, and the server 103 may further acquire the keywords from the guidance summary. For example, in addition to enabling the first language model to output the guidance summary satisfying the first constraint condition, the first prompt data may further enable the first language model to output keywords of the text data. The keywords outputted by the first language model may be selected from the text data, and may also be generated by the first language model according to the semantic meaning of the text data. The keywords outputted by the first language model may be located within the guidance summary. In this way, the server 103 may obtain the keywords from the guidance summary.

For example, the guidance summary outputted by the first language model may include a body section and a keyword section. The body section includes body content of the guidance summary. The keyword section includes one or more keywords of the text data.

In some embodiments of Step 23, the server 103 may retrieve information associated with the one or more keywords as augmentation information.

A database may include one or more of textual elements, images, videos, and audio. The database may be pre-built. The database may be a general-purpose database or a dedicated database. The dedicated database is a database built for specific needs, for example, a database built for a specific domain or a specific task (e.g., a remote assistance scenario for a medical imaging device). For example, the dedicated database may be built according to training manuals, application manuals, operation manuals, operation specifications, technical guidelines, technical standards, textbooks, reference books, etc., in a certain field. The dedicated database may improve the quality of the augmentation information.

The augmentation information retrieved from the database may include one or more of textual elements, images, videos, and audio. The augmentation information may be understood as additional information for assisting the guidance recipient in understanding the guidance summary, thereby improving the readability and practicability of the note. For example, the augmentation information may provide explanations for the content in the guidance summary. In addition, some words in the guidance summary may be polysemous words. Polysemous words have different meanings in different contexts. The augmentation information may help a second language model to understand the meaning of some words in the guidance summary. Therefore, the quality of the note generated by the second language model is improved.

The server 103 may retrieve information including the keywords in the database as the augmentation information. Alternatively, the database may include a plurality of pieces of index information and explanations corresponding to the plurality of pieces of index information, and the server 103 may acquire index information matching the keywords, and select an explanation corresponding to the acquired index from the database as the augmentation information. The index information matching the keyword includes at least one of the following pieces of index information: index information including the keyword; and index information having an expressed semantic meaning consistent with the semantic meaning of the keyword.

For example, the guidance recipient, when encountering a device operation issue, may seek assistance from the guidance provider. The guidance provider may provide assistance to the guidance recipient for the device operation issue. The keyword may include identifier data of the device targeted by the process. The identifier data is configured to identify the device, for example, may be the model and the like of the device. The augmentation information retrieved by the server 103 according to the keyword may include device operation information associated with the identifier data in the database. The note generated in this way not only includes the operation knowledge imparted by the guidance provider but also includes a device operation method related to the device operation knowledge imparted by the guidance provider in the database. For example, the database may be built according to an operation manual for the device. The note generated in this way includes the device operation method related to the operation knowledge imparted by the guidance provider in the operation manual. The guidance recipient, by reading the note, can systematically master and understand the operations of the device. The device may include a medical device, such as an ultrasound device, a CT device, and an MRI device.

In some embodiments, the guidance summary may be referred to as a first note. The note generated by the server 103 according to the augmentation information and the guidance summary not only includes the knowledge in the guidance process, but also includes the augmentation information, and thus may be referred to as a second note. The second note may be considered an enhanced note relative to the first note.

The note may include one or more of textual elements, images, videos, and audio.

In some embodiments of Step 24, the server 103 may, according to the augmentation information and the guidance summary, generate the note using the second language model. For example, the server 103 may input the augmentation information and the guidance summary into the second language model to obtain a note outputted by the second language model. The second language model is a language model for generating notes. The second language model may be a general-purpose model or a dedicated model.

The second language model may fuse the augmentation information and the guidance summary, and output the note. For example, the second language model may combine the augmentation information and the guidance summary, and output the note. For another example, the second language model may also inductively summarize the augmentation information and the guidance summary, and output the note. The second language model may be the same as or different from the first language model.

In some embodiments, the server 103 may generate the note only according to the augmentation information and the guidance summary.

In other embodiments, the second language model can be guided with different prompts, so that the second language model outputs corresponding content according to the guidance prompts. Thus, the server 103 may, according to second prompt data, the augmentation information, and the guidance summary, generate a note using the second language model. For example, the server 103 may input the second prompt data, the augmentation information, and the guidance summary into the second language model to obtain the note outputted by the second language model. Prompting the second language model using the second prompt data can enhance the comprehension of the augmentation information and the guidance summary by the second language model, which is beneficial for generating a high-quality note.

In some examples, the second prompt data may be default.

In other examples, the server 103 may acquire a second prompt word according to the augmentation information and/or the guidance summary, and acquire the second prompt data according to the second prompt word. In this way, the second prompt data may match the augmentation information and/or the guidance summary, to achieve personalized prompting performed on the second language model for the augmentation information and/or the guidance summary.

In the present application, there are one or more second prompt words, and the one or more second prompt words are configured to represent one or more types of environment information of the guidance process. The environment information represented by the second prompt word includes, but is not limited to, the domain of the guidance process, the identity information of the guidance recipient, the object (e.g., the device type) targeted by the guidance process, etc. The second prompt word may be the same as or different from the first prompt word.

The second prompt data is configured to represent a second constraint condition of the note. The second constraint condition is configured to constrain at least one of a subject matter, a word count, an expression style, and a format of the note. For example, the second constraint condition is configured to constrain that: the subject matter of the note is an ultrasound scan, the word count of the note is less than or equal to 1000 words, the note has an expression style suitable for beginners, and the format is an “introduction-body-conclusion” (i.e., topic-supporting details-recap) format. The second constraint condition represented by the second prompt data may restrict the second language model so that the second language model outputs a note that satisfies the requirements of the second constraint condition.

The second constraint condition matches the environment information represented by the second prompt word.

In some scenario examples, the second prompt word is configured to represent the object targeted by the guidance process. The second constraint condition may include the content of the note matching the object represented by the second prompt word. For example, the second prompt word may include “desktop ultrasound device”. The second constraint condition may include “please write a note about the desktop ultrasound device according to supplementary information and the guidance summary”.

In other scenario examples, the second prompt word is configured to represent the identity information of the guidance recipient. The second constraint condition may include the expression style of the note matching the identity information of the guidance recipient. In this way, the note outputted by the second language model can match the cognitive level of the guidance recipient, thereby facilitating the guidance recipient's reading. For example, the second prompt word may include “beginner”. The second constraint condition may include “please write a note from the perspective of a beginner according to the text data”.

The server 103 may select the second prompt word from the augmentation information and/or the guidance summary. For example, the server 103 may select a representative word (e.g., the representative word may be a word of which the frequency of occurrence in the augmentation information and/or the guidance summary meets a predetermined requirement) from the augmentation information and/or the guidance summary as the second prompt word. Alternatively, the server 103 may perform semantic analysis on the augmentation information and/or the guidance summary, and generate the second prompt word according to the semantic meaning of the augmentation information and/or the guidance summary. Certainly, the server 103 may also acquire the second prompt word in other ways.

The server 103 may select prompt data matching the second prompt word from a second prompt data set as the second prompt data. The second prompt data set includes one or more pieces of prompt data. The prompt data in the second prompt data set is configured to prompt the second language model. For example, the server 103 may select prompt data including the second prompt word from the second prompt data set as the second prompt data. Alternatively, the server 103 may further acquire a second prompt template, and generate the second prompt data according to the second prompt word and the second prompt template. The second prompt template may be pre-generated based on prompt engineering. The second prompt template may include a preset textual element and a first position identifier. The first position identifier is configured to indicate the position of the prompt word. The server 103 may replace the first position identifier in the second prompt template with the second prompt word to obtain the second prompt data. The preset textual element in the second prompt template is combined with the second prompt word to collectively express the second constraint condition.

In some examples, the second prompt template may be default.

In other examples, the guidance recipient may input second configuration information into the second terminal device 102, and the second terminal device 102 may transmit the second configuration information to the server 103. The server 103 may generate the second prompt template according to the second configuration information. The second configuration information includes personalized requirement information of the guidance recipient for the note. The personalized requirement information may include, for example: the note is expressed in a combination of text and graphics for ease of reading. In this way, the server 103 may prompt the second language model according to personalized requirements of the guidance recipient, to obtain a note that meets the personalized requirements of the guidance recipient.

The second prompt word corresponds to a dimension identifier, and is configured to represent environment information in a dimension corresponding to the dimension identifier. The second prompt template includes the first position identifier. The first position identifier may include the dimension identifier. The server 103 may use each second prompt word to replace the dimension identifier corresponding to that second prompt word in the second prompt template.

In some scenario examples, the second prompt word may include “beginner”. “Beginner” may correspond to a dimension identifier level. The dimension identifier level is configured to identify a cognitive level dimension. The pre-generated second prompt template may be as shown in Table 6 below.

```
TABLE 6
  Please act as a note-organizing assistant, and according to the draft and supplementary
information of the note, concisely and professionally organize a summary note (no more than
1000 words, and no fabrication is allowed in the answer) with additional knowledge for
{level}.
  The format of the note should be as follows:
  Subject matter: [Write the subject matter here]
  Notes:
  1. [...]
  2. [...]
  [...if there are others]
  Tips:
  1. [...]
  2. [...]
  [...if there are others]
  Other knowledge:
  1. [...]
  2. [...]
  [... if there are others]
```

The server 103 may replace the first position identifier with the second prompt word to obtain the second prompt data as shown in Table 7 below.

```
TABLE 7
  Please act as a note-organizing assistant, and according to the draft and supplementary
information of the note, concisely and professionally organize a summary note (no more than
1000 words, and no fabrication is allowed in the answer) with additional knowledge for a
beginner.
  The format of the note should be as follows:
  Subject matter: [Write the subject matter here]
  Summary:
  1. [...]
  2. [...]
  [...if there are others]
  Tips:
  1. [...]
  2. [...]
  [... if there are others]
  Other knowledge:
  1. [...]
  2. [...]
  [...if there are others]
```

In some implementations of the present embodiment, the server 103 may input the second prompt data, the augmentation information, and the guidance summary into the second language model to obtain the note.

In other implementations of the present embodiment, the server 103 may also fuse the second prompt data, the augmentation information, and the guidance summary, and input the fused data into the second language model to obtain the note. For example, the server 103 may generate the second prompt data fused with the augmentation information and the guidance summary according to the second prompt word, the augmentation information, the guidance summary and the second prompt template. The second prompt data fused with the augmentation information and the guidance summary is input into the second language model to obtain the note. By fusing the second prompt data, the augmentation information, and the guidance summary first, and then inputting the fused second prompt data, augmentation information, and guidance summary into the second language model, the second language model can fully understand the contextual relevance among the first prompt data, the augmentation information, and the guidance summary, thereby improving the quality of the note outputted by the second language model.

In addition to including the preset textual element and the first position identifier, the second prompt template may further include a third position identifier and a fourth position identifier. The third position identifier is configured to indicate the position of the guidance summary. The fourth position identifier is configured to indicate the position of the supplementary information. The server 103 may replace the first position identifier with the second prompt word, replace the third position identifier with the guidance summary, and replace the fourth position identifier with the supplementary information, to obtain the second prompt data fused with the augmentation information and the guidance summary.

In some scenario examples, the second prompt word may include “beginner”. “Beginner” may correspond to a dimension identifier level. The dimension identifier level is configured to identify a cognitive level dimension. The third position identifier may be summary. The fourth position identifier may be added. The pre-generated second prompt template may be shown in Table 8 below.

```
TABLE 8
  Please act as a note-organizing assistant, and according to the draft and supplementary
information of the note, concisely and professionally organize a summary note (no more than
1000 words, and no fabrication is allowed in the answer) with additional knowledge for
{level}.
  The format of the note should be as follows:
  Subject matter: [Write the subject matter here]
  Notes:
  1. [...]
  2. [...]
  [...if there are others]
  Tips:
  1. [...]
  2. [...]
  [...if there are others]
  Other knowledge:
  1. [...]
  2. [...]
  [...if there are others]
  The following is the guidance summary and supplementary information for reference.
  [summary]
  [add]
```

The server 103 may replace the first position identifier with the second prompt word, replace the third position identifier with the guidance summary, and replace the fourth position identifier with the supplementary information, to obtain the second prompt data as shown in Table 9 below.

```
TABLE 9
  Please act as a note-organizing assistant, and according to the draft and supplementary
information of the note, concisely and professionally organize a summary note (no more than
1000 words, and no fabrication is allowed in the answer) with additional knowledge for a
beginner.
  The format of the note should be as follows:
  Subject matter: [Write the subject matter here]
  Summary:
  1. [...]
  2. [...]
  [...if there are others]
  Tips:
  1. [...]
  2. [...]
  [...if there are others]
  Other knowledge:
  1. [...]
  2. [...]
  [...if there are others]
  The following is the guidance summary and supplementary information for reference.
  <Guidance summary>
  <Supplementary information>
```

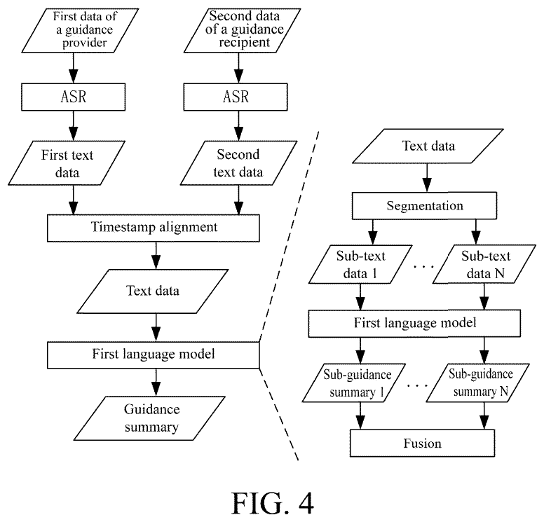

FIG. 4 is a schematic diagram of a note generation approach according to other embodiments of the present specification, and is used for illustrating other embodiments of Step 22.

As shown in FIG. 4, in some examples, the server 103 may segment the text data (e.g., the text data obtained in Step 21) to obtain a plurality of pieces of sub-text data; extract corresponding sub-guidance summaries according to the sub-text data; and fuse the plurality of sub-guidance summaries to obtain the guidance summary.

In some cases, the guidance summary is extracted using a language model. Constrained by computational resources, it may be impossible to input a large number of words into the language model at one time. The computational resources may include a memory, a CPU (central processing unit), a video memory, a GPU (graphics processing unit), etc. Text data having a large number of words is segmented, which can overcome the limitation of the number of words inputted into the language model, and achieve the extraction of the guidance summary from the text data.

The server 103 may detect whether the text data satisfies a segmentation condition. The segmentation condition includes, but is not limited to, at least one of the following conditions: the word count of the text data is greater than or equal to a first set threshold; and the size of the text data is greater than or equal to a second set threshold. The size of the text data may include the space capacity occupied by the text data on a storage medium. When the text data satisfies the segmentation condition, the server 103 may segment the text data to obtain the plurality of pieces of sub-text data. Each piece of sub-text data may not satisfy the segmentation condition. In addition, when the text data does not satisfy the segmentation condition, the server 103 may not segment the text data.

The server 103 may, according to the sub-text data, generate the sub-guidance summaries using the first language model. For example, the server 103 may input the sub-text data into the first language model to obtain sub-guidance summaries outputted by the first language model.

The server 103 may generate the sub-guidance summaries using the first language model only according to the sub-text data. Alternatively, the server 103 may also generate the sub-guidance summaries using the first language model according to sub-prompt data and the sub-text data. For example, the server 103 may input the sub-prompt data and the sub-text data into the first language model to obtain the sub-guidance summaries outputted by the first language model.

The sub-prompt data may be default. Alternatively, the server 103 may acquire a sub-prompt word according to the sub-text data; and may acquire the sub-prompt data according to the sub-prompt word. In this way, the sub-prompt data may match the sub-text data.

The sub-prompt word is configured to represent environment information of the guidance process. There are one or more sub-prompt words. The environment information represented by the sub-prompt word includes, but is not limited to, the domain of the guidance process, the identity information, e.g., cognitive level, etc., of the guidance recipient. The sub-prompt data is configured to represent a sub-constraint condition of the guidance summary. The sub-constraint condition is configured to constrain at least one of a subject matter, a word count, an expression style, and a format of the sub-guidance summary.

The sub-constraint condition may match the environment information represented by the sub-prompt word.

The server 103 may select the sub-prompt word from the sub-text data. For example, the server 103 may select a representative word (e.g., the representative word may be a word of which the frequency of occurrence in the sub-text data meets a predetermined requirement) from the sub-text data as the sub-prompt word. Alternatively, the server 103 may perform semantic analysis on the sub-text data; and may generate the sub-prompt word according to the semantic meaning of the sub-text data. Certainly, the server 103 may further acquire the sub-prompt word in other ways.

The server 103 may select prompt data matching the sub-prompt word from the first prompt data set as the sub-prompt data. For example, the server 103 may select prompt data including the sub-prompt word from the first prompt data set as the sub-prompt data. Alternatively, the server 103 may acquire a sub-prompt template; and may generate the sub-prompt data according to the sub-prompt word and the sub-prompt template. The sub-prompt template is pre-generated based on prompt engineering. The sub-prompt template includes a preset textual element and a first position identifier. The first position identifier is configured to indicate the position of the prompt word. The server 103 may replace the first position identifier with the sub-prompt word to obtain the sub-prompt data. The preset textual element in the sub-prompt template is combined with the sub-prompt word to collectively express the sub-constraint condition.

The sub-prompt template may be default. Alternatively, the guidance recipient may input sub-configuration information into the second terminal device 102. The second terminal device 102 may transmit the sub-configuration information to the server 103. The server 103 may generate the sub-prompt template according to the sub-configuration information. The sub-configuration information includes personalized demand information of the guidance recipient for the sub-guidance summaries.

In some implementations of the present embodiment, the server 103 may separately input the sub-prompt data and the sub-text data into the first language model to obtain the sub-guidance summaries. In other implementations of the present embodiment, the server 103 may also fuse the sub-prompt data and the sub-text data; and may input the fused data into the first language model to obtain the sub-guidance summaries. For example, the server 103 may generate sub-prompt data fused with the sub-text data according to the sub-prompt word, the sub-text data, and the first prompt template, and may input the sub-prompt data fused with the sub-text data into the first language model to obtain the sub-guidance summaries.

The server 103 may fuse the plurality of sub-guidance summaries to obtain the guidance summary. For example, the server 103 may combine the plurality of sub-guidance summaries to obtain the guidance summary. Specifically, for example, the server 103 may combine the plurality of sub-guidance summaries according to the positions of the sub-text data corresponding to the sub-guidance summaries in the plurality of sub-text data, to obtain the guidance summary. Certainly, the server 103 may also fuse the plurality of sub-guidance summaries in other ways, to obtain the guidance summary.

The server 103 may acquire keywords of the plurality of pieces of sub-text data; and may determine keywords of the text data according to the keywords of the plurality of sub-text data. The keywords of the text data may include the keywords of the plurality of pieces of sub-text data. In some implementations of the present embodiment, the server 103 may select the keywords from the sub-text data. For example, the server 103 may select, as a keyword, a headword of a questioning sentence of the guidance recipient from the sub-text data. In other implementations of the present embodiment, the server 103 may also generate the keyword according to the semantic meaning of the sub-text data. In other implementations of the present embodiment, in addition to enabling the first language model to output the sub-guidance summaries, the sub-prompt data may further enable the first language model to output the keywords of the sub-text data. The keywords outputted by the first language model may be selected from the sub-text data, or may be generated by the first language model according to the semantic meaning of the sub-text data. The keywords outputted by the first language model may be located within the sub-guidance summaries. In this way, the server 103 may acquire the keywords from the sub-guidance summaries.

For example, each sub-guidance summary outputted by the first language model includes a body section and a keyword section. The body section includes body content of the sub-guidance summary. The keyword section includes one or more keywords of the sub-text data.

In some embodiments, the server 103 may further transmit the generated note to the guidance recipient-oriented terminal device. The terminal device may receive the note. In this way, the guidance recipient can obtain the note after the guidance process is completed. The guidance recipient, by reading the note, can quickly understand or apply the knowledge from the guidance process, thereby improving the skills of the guidance recipient.

In the technical solution of the embodiments of the present specification, speech recognition may be performed on data of a guidance process to obtain text data; a guidance summary may be extracted according to the text data; augmentation information associated with the guidance summary may be retrieved; and a note of the guidance process may be generated according to the augmentation information and the guidance summary. Problems for which the guidance recipient seeks assistance are often non-routine, so a one-time guidance process might not enable the guidance recipient to master the knowledge in the guidance process. The guidance recipient may forget after a certain period of time. The note may prevent the guidance recipient from forgetting or reduce the amount of knowledge forgotten by the guidance recipient. Additionally, the note includes the guidance summary. The guidance summary is an inductive summarization of the content expressed by the guidance provider and/or the guidance recipient in the guidance process and can accurately and concisely represent the key points expressed by the guidance provider and/or the guidance recipient in the guidance process. The note further includes the augmentation information associated with the guidance summary. The augmentation information may assist in understanding the guidance summary. Therefore, the note generated in the embodiments of the present specification has better readability and practicability. The guidance recipient, by reading the note, can quickly understand or apply the knowledge from the guidance process, thereby improving the skills of the guidance recipient.

A specific scenario example according to an embodiment of the present specification will be described below. The scenario example is only for better understanding the technical solutions according to the embodiments of the present specification, but does not constitute inappropriate limitations on the technical solutions according to the embodiments of the present specification.

Doctor Alice, when performing an ultrasound scan on a patient using a medical ultrasound device, finds that it is difficult to obtain a clear image of the gallbladder. Doctor Alice then clicks a help button on the medical ultrasound device to seek assistance from a technician of the medical instrument company. Technician Bob can provide remote scanning guidance to Doctor Alice via a remote guidance tool. The remote guidance tool may include instant messaging software, etc. Alice may be referred to as the guidance recipient, and Bob may be referred to as the guidance provider. The medical ultrasound device is the guidance recipient-oriented first terminal device 101, and Technician Bob's computer is the guidance provider-oriented second terminal device 102.

The medical ultrasound device may collect Alice's data during the remote scanning guidance process and may transmit Alice's data to the server 103. Bob's computer may collect Bob's data during the remote scanning guidance process, and may transmit Bob's data to the server 103. The server 103 may respectively perform speech recognition on Alice's data and Bob's data during the remote scanning guidance process to obtain Alice's first text data and Bob's second text data; and may fuse the first text data and the second text data to obtain text data. The text data may include, for example, the content as shown in Table 10 below.

```
TABLE 10
  Alice: I am having difficulty obtaining a clear image of the gallbladder. Could you take
a look and provide some guidance?
  Bob: Of course! Could you show me the current image and the settings you're using?
```

The server 103 may, according to first prompt data and the text data, generate a guidance summary using a first language model. The first prompt data is configured to represent a first constraint condition. The first constraint condition is configured to constrain a subject matter, a word count, an expression style, a format, and the like of the guidance summary. The guidance summary generated by the first language model may satisfy the first constraint condition.

The guidance summary may include one or more keywords. The server 103 may retrieve information associated with the keywords in a database as augmentation information. The database may be a dedicated database. The dedicated database is a database built for remote scanning guidance. The dedicated database may be built according to a scanning technical guideline, a medical device operation manual, etc.

The server 103 may, according to second prompt data, the augmentation information, and the guidance summary, generate a note using a second language model. The second prompt data is configured to represent a second constraint condition. The second constraint condition is configured to constrain a subject matter, a word count, an expression style, a format, and the like of the guidance summary. The note generated by the second language model may satisfy the second constraint condition.

The note generated by the server 103 may include, for example, the content shown in Table 11 below.

```
TABLE 11
  Subject matter: Gallbladder Ultrasound Examination
  Summary:
  1. Use of a 3.5 MHz frequency and a transverse plane can better display the gallbladder
wall; and
  2. Check for signs of gallstones (small shadows or echo foci) and other abnormalities
(e.g., wall thickening, fluid accumulation).
  Tips:
  1. Adjustment of the frequency and the plane can optimize the image quality;
  2. Use of measurement tools ensures accurate calculations;
  3. Check the entire gallbladder and surrounding tissues for signs of lesions.
  Other knowledge:
  1. Measurement reference values;
  1.1 A normal gallbladder has a long diameter generally not exceeding 8.5 cm and an
anteroposterior diameter generally not exceeding 3.5 cm. The anteroposterior diameter better
reflects the tension of the gallbladder than the long diameter;
  1.2 The thickness of a normal gallbladder wall at fasting does not exceed 2.5 mm. The
probe must be perpendicular to the gallbladder wall during measurement, otherwise it may
cause an illusion of gallbladder wall thickening;
  2. Managing your presets
  2.1 To facilitate next use, you may save the preset values of the gallbladder probe. Press
the probe button on the touch screen. Select the probe that needs to be configured, then click
the preset configuration button below. After the presets are optimized, click Save/Create.
  The following is the guidance summary and supplementary information for reference.
  <Guidance summary>
  <Supplementary information>
```

Since the problem for which Alice is seeking assistance is non-routine, one-time remote scanning guidance might not enable Alice to master the knowledge imparted by Bob. Alice may forget after a certain period of time. The note may prevent Alice from forgetting or reducing the amount of knowledge forgotten by Alice. Additionally, the note not only includes the knowledge imparted by Bob during the remote scanning guidance but also includes additional augmentation information. Thus, the readability and practicability of the note are improved. Alice, through the note, can quickly understand or use the knowledge imparted by Bob.

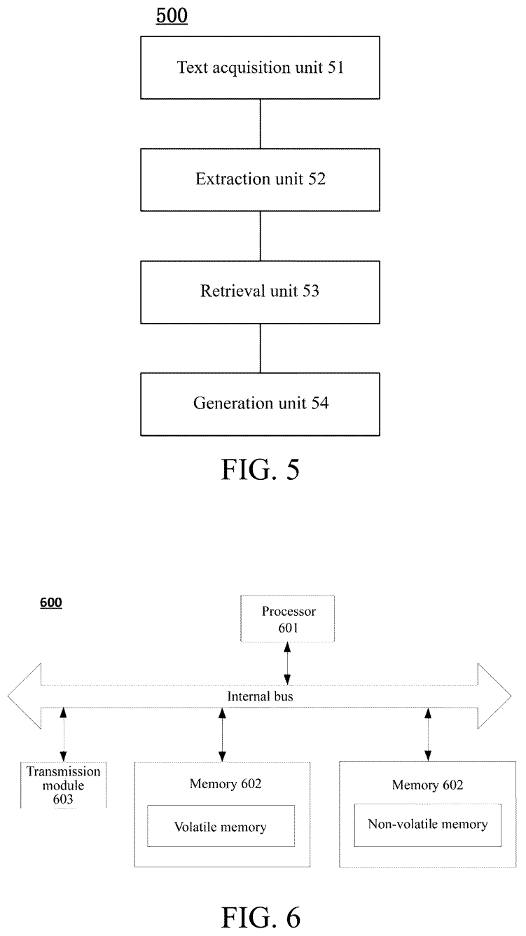

As shown in FIG. 5, according to the note generation system 100, some embodiments of the present specification further provide a note generation apparatus. The note generation apparatus 500 can be applied to the server 103. As shown in FIG. 5, the note generation apparatus 500 may include the following units:

a text acquisition unit 51, configured to perform speech recognition on data of a guidance process and obtain text data;

an extraction unit 52, configured to extract a guidance summary according to the text data;

a retrieval unit 53, configured to retrieve augmentation information associated with the guidance summary; and

a generation unit 54, configured to generate a note of the guidance process according to the augmentation information and the guidance summary.

It should be noted that since the implementation solution for problem-solving by the above apparatus is similar to that of the above method. For the specific implementation of the apparatus in the embodiments of the present specification, reference can be made to the implementation of the above method, and repeated details are omitted. The term “unit” used below may be a combination of software and/or hardware that implements a predetermined function. Although the apparatus described in the following embodiments is preferably implemented by software, implementation by hardware or a combination of software and hardware is also possible and conceived of.

The embodiments of the present specification further provide a computer device. The computer device includes a memory, a processor, and a computer program stored in the memory and executable on the processor. When executing the computer program, the processor implements the note generation method described above.

The memory may be used to store information. The memory may include any one or a combination of: any type of RAM, any type of ROM, a flash memory device, a hard disk, an optical disk, etc. The processor may include any one or a combination of: a central processing unit (CPU), a graphics processing unit (GPU), a micro processing unit (MCU), a programmable logic device (FPGA), etc.

The embodiments of the present specification further provide a computer-readable storage medium having a computer program stored thereon. When the computer program is executed by a processor, the note generation method described above is implemented.

The computer-readable storage medium may include: apparatuses that store information using electrical energy, such as various memories, e.g., RAM, ROM, etc., apparatuses that store information using magnetic energy, such as hard disks, floppy disks, magnetic tapes, magnetic core memories, bubble memories, and U disks; and apparatuses that store information using optical means, such as CDs or DVDs. Certainly, there are other forms of readable storage media, such as quantum memories, graphene memories, etc.

The embodiments of the present specification further provide a computer program product, comprising a computer program. The computer program, when executed by a processor, implements the note generation method described above.

FIG. 6 is a schematic diagram of the architecture of a computer device in some embodiments of the present specification. The computer device can be configured to implement the functions of the server 103 of the note generation system 100 in the embodiments of the present specification. As shown in FIG. 6, the computer device 600 may include one or more (only one shown) processors 601, a memory 602 for storing data, and a transmission module 603 for communication functions. It can be understood by those of ordinary skill in the art that the structure shown in FIG. 6 is only illustrative and does not limit the structure of the computer device 600. For example, the computer device may further include more or fewer components than those shown in FIG. 6, for example, may further include other processing hardware, such as a database, a multi-level cache, or a GPU, or have a configuration different from that shown in FIG. 6.

The memory 602 may be configured to store software programs and modules of application software, and the processor 601 executes various functional applications and data processing by running the software programs and modules stored in the memory 602. The memory 602 may also include a volatile memory such as a high-speed random access memory. The memory 602 may further include a non-volatile memory, such as one or more magnetic storage devices, flash memory, or other non-volatile solid-state memory. In some embodiments, the memory 602 may further include memories remotely disposed relative to the processor 601, and these remote memories may be connected to the computer terminal via a network. Examples of the above network include, but are not limited to, the Internet, an intranet, a local area network, a mobile communication network, and combinations thereof.

The transmission module 603 is configured to receive or send data via a network. The specific examples of the network may include a wireless network provided by a communication supplier of the computer terminal. In an example, the transmission module 603 includes a network interface controller (NIC) which may be connected to other network devices via a base station to communicate with the Internet. In an example, the transmission module 603 may be a radio frequency (RF) module which is configured to communicate with the Internet in a wireless manner.

It can be understood by those skilled in the art that the present specification may be provided as a method, a system, or a computer program product. Therefore, the present specification may be implemented in the form of a fully hardware-based embodiment, a fully software-based embodiment, or an embodiment combining software and hardware.

Furthermore, the present specification may be implemented in the form of a computer program product implemented on one or more computer-usable storage media (including, but not limited to, magnetic disk storage, CD-ROM, optical storage, etc.) having computer-usable program codes included therein.

The present specification is described with reference to flowcharts and/or block diagrams of methods, devices (systems), and computer program products according to the embodiments of the present specification. It should be understood that each flow and/or block in the flowcharts and/or block diagrams and a combination of flows and/or blocks in the flowcharts and/or block diagrams may be implemented by computer program instructions. The computer may be a personal computer, a laptop computer, a cellular telephone, a camera phone, a smart phone, a personal digital assistant, a media player, a navigation device, an email device, a gaming console, a tablet computer, a wearable device, or a combination of any of these devices.

Each functional unit in the embodiments of the present specification may be integrated into one processing unit, or each functional unit may exist alone physically, or two or more functional units may be integrated into one processing unit.

It can be understood by those skilled in the art that the description of each embodiment in the present specification has its own focus, and for a part not described in detail in a certain embodiment, reference may be made to the related description of other embodiments. In addition, it may be understood that any combination of some or all of the embodiments described in the present specification can be conceived of by those skilled in the art without the exercise of any inventive effort after reading the document of the present specification, and such combinations are also within the scope of the disclosure and protection of the present specification.

Although the present specification has been described by way of embodiments, those of ordinary skill in the art will appreciate that the above embodiments are only used to facilitate understanding of the core idea of the present specification. It can be understood by those skilled in the art that many modifications and variations of the present specification are possible. It is intended that the appended claims cover such modifications and variations without departing from the spirit of the present specification.

1. A note generation method, characterized by comprising:
performing speech recognition on data of a guidance process and obtaining text data;
extracting a guidance summary according to the text data;
retrieving augmentation information associated with the guidance summary; and
generating a note of the guidance process according to the augmentation information and the guidance summary.

2. The method according to claim 1, wherein,
the data comprises first data of a guidance provider and second data of a guidance recipient; and
the performing speech recognition on data of a guidance process and obtaining text data comprises:
performing speech recognition on the first data to obtain first text data;
performing speech recognition on the second data to obtain second text data; and
fusing the first text data and the second text data according to a conversation sequence of the guidance provider and the guidance recipient to obtain the text data.

3. The method according to claim 1, wherein the extracting a guidance summary comprises:
segmenting the text data to obtain a plurality of pieces of sub-text data;
extracting corresponding sub-guidance summaries according to the sub-text data; and
fusing the plurality of sub-guidance summaries to obtain the guidance summary.

4. The method according to claim 1, wherein the extracting a guidance summary comprises:
according to the text data, generating the guidance summary using a first language model.

5. The method according to claim 4, wherein the method further comprises:
acquiring a first prompt word according to the text data; and
acquiring first prompt data according to the first prompt word, the first prompt data being configured to represent a first constraint condition; and
the generating the guidance summary using a first language model comprises:
according to the first prompt data and the text data, generating, using the first language model, a guidance summary satisfying the first constraint condition.

6. The method according to claim 5, wherein the first prompt word is configured to represent identity information of a guidance recipient, and the first constraint condition comprises an expression style of the guidance summary matching the identity information of the guidance recipient.

7. The method according to claim 1, wherein the guidance summary comprises a keyword; and
the retrieving augmentation information associated with the guidance summary comprises:
retrieving information associated with the keyword in a database as the augmentation information.

8. The method according to claim 7, wherein the keyword comprises identifier data of a device targeted by the guidance process, and the augmentation information comprises a device operation method associated with the identifier data in the database.

9. The method according to claim 1, wherein the generating a note of the guidance process comprises:
according to the augmentation information and the guidance summary, generating the note using a second language model.

10. The method according to claim 9, wherein the method further comprises:
acquiring a second prompt word according to at least one of the augmentation information and the guidance summary; and
acquiring second prompt data according to the second prompt word, the second being prompt data configured to represent a second constraint condition; and
the generating the note using a second language model comprises:
according to the second prompt data, the augmentation information, and the guidance summary, generating, using a second language model, a note satisfying the second constraint condition.

11. The method according to claim 10, wherein the second prompt word is configured to represent identity information of a guidance recipient, and the second constraint condition comprises an expression style of the note matching the identity information of the guidance recipient.

12. A computer device, characterized by comprising:
at least one processor; and
a memory storing program instructions, wherein the program instructions are configured to be adapted to be executed by the at least one processor, and the program instructions comprise instructions for executing;
a text acquisition unit, configured to perform speech recognition on data of a guidance process and obtain text data;
an extraction unit, configured to extract a guidance summary according to the text data;
a retrieval unit, configured to retrieve augmentation information associated with the guidance summary; and
a generation unit, configured to generate a note of the guidance process according to the augmentation information and the guidance summary.

13. (canceled)

14. (canceled)

15. The computer device of claim 12, wherein,
the data comprises first data of a guidance provider and second data of a guidance recipient; and
the performing speech recognition on data of a guidance process and obtaining text data comprises:
performing speech recognition on the first data to obtain first text data;
performing speech recognition on the second data to obtain second text data; and
fusing the first text data and the second text data according to a conversation sequence of the guidance provider and the guidance recipient to obtain the text data.

16. The computer device of claim 12, wherein the extracting a guidance summary comprises:
segmenting the text data to obtain a plurality of pieces of sub-text data;
extracting corresponding sub-guidance summaries according to the sub-text data; and
fusing the plurality of sub-guidance summaries to obtain the guidance summary.

17. The computer device of claim 12, wherein the extracting a guidance summary comprises:
according to the text data, generating the guidance summary using a first language model.

18. The computer device of claim 17, wherein the program instructions comprise instructions for:
acquiring a first prompt word according to the text data; and
acquiring first prompt data according to the first prompt word, the first prompt data being configured to represent a first constraint condition; and
the generating the guidance summary using a first language model comprises:
according to the first prompt data and the text data, generating, using the first language model, a guidance summary satisfying the first constraint condition.

19. The computer device of claim 18, wherein the first prompt word is configured to represent identity information of a guidance recipient, and the first constraint condition comprises an expression style of the guidance summary matching the identity information of the guidance recipient.

20. The computer device of claim 12, wherein the guidance summary comprises a keyword; and
the retrieving augmentation information associated with the guidance summary comprises:
retrieving information associated with the keyword in a database as the augmentation information.

21. A non-transitory computer program product, comprising a computer program, wherein the computer program, when executed by a processor, implements instructions comprising:
a text acquisition unit, configured to perform speech recognition on data of a guidance process and obtain text data;
an extraction unit, configured to extract a guidance summary according to the text data;
a retrieval unit, configured to retrieve augmentation information associated with the guidance summary; and
a generation unit, configured to generate a note of the guidance process according to the augmentation information and the guidance summary.

22. The non-transitory computer program product of claim 21, wherein the extracting the guidance summary comprises, according to the text data, generating the guidance summary using a first language model.
